(19) United States
(12) Patent Application Publication
(10) Pub. No.: US 2005/0186117 A1
(43) Pub. Date: Aug. 25, 2005

(54) Gas detecting method and gas sensors

(76) Inventors: Hiroyuki Uchiyama, Musashimurayama (JP); Kazuhiro Mochizuki, Tokyo (JP); Akihisa Terano, Hachioji (JP); Teruyuki Nakamura, Hitachi (JP); Akihito Hongo, Tuchiura (JP); Tomoyoshi Kumagai, Hitachi (JP)

Correspondence Address: REED SMITH LLP, Suite 1400, 3110 Fairview Park Drive, Falls Church, VA, 22042, US

(21) Appl. No.: 10/914,271

(22) Filed: Aug. 10, 2004

(30) Foreign Application Priority Data
May 14, 2004 (JP) 2004-144726
Feb. 19, 2004 (JP) 2004-042457

(51) Int. Cl. G01N 21/00

(52) U.S. Cl. 422/91; 436/164

(57) ABSTRACT

A gas detection method capable of solving the problem with respect to the operation at normal temperature that was impossible so far in the existent catalyst type sensor and detection with high sensitivity that was impossible by the light absorption type sensor. A multi-layered film formed of a first layer adsorbing a specified gas and a second layer having less adsorption are utilized as a detection film, and the detection film is disposed in the direction perpendicular to the optical channel and optically detects the change of stress caused in the detection film by gas adsorption as coupling loss. Alternatively, the stress generated in the detection film caused by gas adsorption is electrically detected by a piezoelectric element or capacitance element.

### CLAIM OF PRIORITY

The present application claims priority from Japanese application JP 2004-144726 filed on May 14, 2004 and Japanese application JP 2004-042457 filed on Feb. 19, 2004, the content of which is hereby incorporated by reference into this application.

### BACKGROUND OF THE INVENTION

1. Field of the Invention

The present invention relates to a gas sensor for measuring the concentration of a gas and, particularly, it relates to a hydrogen sensor.

2. Description of the Related Art

For realization of the coming hydrogen energy society, infrastructure building of hydrogen stations, etc. and development for hydrogen-fueled vehicles and fuel cells have been developed vigorously. In a case of utilizing high pressure hydrogen reservoirs for hydrogen-fueled vehicles, in view of serious risk of explosion, every automobile manufacturers adopt safety countermeasure of installing a hydrogen detector at least to one place in each of a residential compartment and a high pressure hydrogen line for automatically shutting a main valve to a high pressure hydrogen reservoir in the event of leakage of hydrogen. Among hydrogen sensors used at present SnOₓ series semiconductor sensors described, for example, in JP-A No. 11-094786 are predominant. However, since the sensors utilize the catalytic effect, they involve a problem in that the detection portion has always to be kept at a temperature of about 300 to 400° C. In addition, they cannot accurately detect the hydrogen concentration in the coexistence of gases such as methane and carbon monoxide since they have inhibiting effects. Further, it is also a significant problem in that it takes a long rise time till normal operation of the detector.

On the other hand, a light absorption type sensor described, for example, in JP-A No 60-03536, has been reported which utilizes occurrence of light at specified wavelength when a predetermined compound is hydrogenated or adsorbed. However, this involves problems, for example, in that the sensitivity is as low as from several % to several tens % since absorption of light at a specified wavelength is detected and the responsivity is poor. Further, a method, for example, described in JP-A No. 2002-323441 is also known which forms a thin metal film that adsorbs hydrogen on an optical waveguide channel and optically detects the expansion of the film caused by adsorption; however, close contact with the waveguide channel is poor to result in a problem of lacking in practical usability such as being poor in the reliability as the device.

Generally, known gas sensors for detecting combustible gases incorporating hydrogen or the like include a semiconductor type, as well as a contact combustion type and optical detection type and, in the case of the combustible gas, the optical detection type hydrogen sensor is suitable since it can detect hydrogen at normal temperature and has high safety and is excellent in explosion proofness not having an ignition source such as an electric contacts.

This uses a material which absorbs molecules of hydrogen or atoms of hydrogen to change its optical characteristics for the sensor device and when it is exposed to the hydrogen containing atmosphere, the material causes change of color or expansion and, accordingly, changes the light absorptivity, light transmittance, surface roughness, and volume of the material per se. When light is applied to the sensor device in this instance, since the amount of reflection light or the amount of transmission light changes in comparison with that before exposure to the hydrogen atmosphere, presence of hydrogen is detected by measuring the change.

An example is a hydrogen detection device manufactured by forming a hydrous tungsten oxide film on a flat tungsten substrate by using an anodizing method and then thinly depositing a palladium film as a catalyst film by vacuum vapor deposition or sputtering (refer to JP-A No. 7-72080).

It is described that when the atmosphere in which the detection device is placed is changed from usual air to an air containing 1% hydrogen with light having a wavelength of 1.4 μm directed from the surface to the substrate, it responses to hydrogen in about 10 sec, that is, the amount of reflection light changes in this method.

In this method, the device comprises a stacked film of a metal oxide formed of a hydrous tungsten oxide film and a catalyst film formed of a palladium film, in which hydrogen molecules are dissociated into hydrogen atoms upon adsorption to palladium, the dissociated hydrogen atoms act on the hydrous tungsten oxide film located below the palladium film to cause color change and result in the change of absorptivity and reflectance of light in the hydrous tungsten oxide film. The structure has been known as one of hydrogen detection devices with a high degree of sensitivity capable of detecting the presence of hydrogen to a low concentration region.

Another example is a light detection type hydrogen detection device manufactured by forming, for example, only a thin Pd (palladium) film as a catalyst metal on a substrate (refer to JP-A No. 5-196569).

This detects the presence of hydrogen by measuring the change of the light transmittance or light reflectivity of the Pd film itself caused by hydrogen occlusion in the Pd film. It is described that this is device having a higher response speed compared with the detection device using the metal oxide.

The problem to be solved by the invention resides in the gas selectivity and rising property in the SnOₓ based semiconductor sensor or the like, as well as poor sensitivity and response in the light absorption type sensor at a predetermined wavelength, and the device reliability in the adsorption waveguide channel type sensor.

### SUMMARY OF THE INVENTION

In view of the above, it is an object of the present invention to provide a hydrogen sensor having high sensitivity and stable detection performance and, at the same time, a light detection type hydrogen detection device outstandingly improved for the life more than usual with high sensitivity and stable detection performance maintained, as well as a hydrogen sensor mounting the same.

The invention adopts a detection method different from the surface catalytic reaction in the semiconductor type sensor, and the absorption for the specified light wavelength due to the product of solid reaction with the gas in the light absorption type sensor. A stacked structure of a layer causing remarkable volumic expansion by adsorption of a specified gas and a layer scarcely adsorbing gas is formed in which stress is generated upon adsorption of a gas to cause folding of the stacked film. Accordingly, an optical change in the multi-layered film caused by the change of stress due to adsorption of the specified gas is detected with no requirement of heating the device to a high temperature and not requiring usual detection current. Further, to improve the reliability of the device, a thin metal film with poor close adhesion is not used as the detection film but a ceramic material such as a metal oxide film having good close adhesion with a support substrate is utilized as the detection film.

Further, the present invention provides an optical detection type hydrogen detection device in which a catalyst metal film is formed on a transparent substrate or a metal oxide wherein the maximum length in a region for forming a catalyst metal film on one and the same surface is defined to 70 μm or less. With the use of the device of this structure, existent high sensitivity and stable detection performance can be maintained for the hydrogen detection and, at the same time, improvement for the device can be attained.

Further, a single layer of catalyst film, or a dual layer-structured film of catalyst film/metal oxide may be formed not only on the surface of a transparent substrate but also on the rear face thereof. Since the hydrogen detection area is doubled by forming the same on both of the surface and the rear face, the sensitivity can be improved further.

While a circular or rectangular pattern shape is used in the experiment, it will be apparent that a pattern of any shape such as elliptic, polygonal or like other shapes can be used so long as the maximum length in the patterned region of the catalyst metal film on one and the same plane is 70 μm or less.

Further, other forms than the pattern of a determined size may also be adopted. In a case of the dual layer-structured catalyst film/metal oxide, it will be apparent that the purpose of the invention can be attained also in a case of forming metal oxide comprising amorphous or indefinite crystal grains of different size or shape of about 0.1 to 10 μm in size sparsely over the entire surface of a transparent substrate and then depositing a catalyst film over the entire upper surface thereof.

Further, while tungsten oxide is used for the metal oxide and palladium is used for the catalyst metal in the experiment described above, also in a case of using vanadium oxide or molybdenum oxide for the metal oxide and platinum for the catalyst metal and conducting the hydrogen exposure experiment in each of the combinations, deterioration of the catalyst metal film in view of the shape was not caused in any combination so long as within the range of the size of the catalyst metal film pattern.

According to the invention, detection for the gas leakage upon starting can be attained easily, which was impossible so far in the existent semiconductor type gas detector.

Further, in the optical detection, a complete explosion proof structure can be obtained easily which enables use in the mode like a densitometer for the process control that was difficult to be applied thereto so far. Further, by the use of a detection film that adsorbs only the specified gas, extremely high gas selectivity is provided and only the gas component intended to be measured can be detected with good accuracy even in a circumstance where various kinds of gases are present together.

Furthermore, the detection device itself can be decreased in size and reduced in weight and can be mounted easily to portable equipment.

### BRIEF DESCRIPTION OF THE DRAWINGS

Preferred embodiments of the present invention will be described in details based on the drawings, wherein

FIG. 1A is a view explaining a light transmission type gas detection system according to the present invention shown in Example 1 (not exposed to detection gas);

FIG. 1B is a view explaining a light transmission type gas detection system according to the present invention shown in Example 1 (exposed to detection gas);

FIG. 2A is a view explaining the state of carrying a gas detection film and a catalyst material of the invention shown in Example 1 (in a case of structure carrying them in an island shape);

FIG. 2B is a view explaining the state of carrying a gas detection film and a catalyst material of the invention shown in Example 1 (in a case of structure carrying them in a network shape);

FIG. 2C is a view explaining the state of carrying a gas detection film and a catalyst material of the invention shown in Example 1 (in a case of deposition sparsely in nano-order within the fine structure of detection film);

FIG. 3A is a diagram showing a relation between the wavelength and the change of light intensity in a case of using the invention shown in Example 1 to hydrogen detection (in atmospheric air→exposure to 1% hydrogen);

FIG. 3B is a diagram showing a relationship between the wavelength and the change in light intensity in a case of using the invention shown in Example 1 to hydrogen detection (exposure to 1% hydrogen→opening to the atmosphere);

FIG. 4 is a view showing a constitutional example of a system without using light source in a gas detection device of the invention shown in FIG. 1;

FIG. 5 is a diagram for explaining the response property and return property in a case of applying the invention shown in Example 1 to hydrogen detection;

FIG. 6 is a chart for explaining the degradation of the performance of a detection film and the regeneration of the detection film by heating in a case of applying the invention shown in Example 1 to hydrogen detection;

FIG. 7A is a view showing a constitutional example of incorporating a heating heater to a gas detection film of the invention shown in Example 1 (thin film heater on the back of the support substrate);

FIG. 7B is a view showing a constitutional example of incorporating a heating heater to a gas detection film of the invention shown in Example 1 (support substrate itself utilized as the thin film heater);

FIG. 7C is a view showing a constitutional example of incorporating a heating heater to a gas detection film of the invention shown in Example 1 (detection film itself utilized as the thin film heater);

FIG. 8A is a diagram for explaining the selectivity to a specified gas in a case of applying the invention shown in Example 1 to hydrogen detection (in a case of exposure to 1% carbon monoxide);

FIG. 8B is a diagram for explaining the selectivity to a specified gas in a case of applying the invention shown in Example 1 to hydrogen detection (exposed to methane);

FIG. 9A is a view for explaining the form of a detection film of the invention shown in Example 1 (cross sectional view for both end-supported beam structure, not exposed to detection gas);

FIG. 9B is a view for explaining the form of a detection film of the invention shown in Example 1 (cross sectional view for both end-supported beam structure, exposed to detection gas);

FIG. 9C is a view for explaining the form of a detection film of the invention shown in Example 1 (front elevational view of both end-supported beam structure);

FIG. 9D is a view for explaining the form of a detection film of the invention shown in Example 1 (front elevational view of four-side fixed structure);

FIG. 9E is a view for explaining the form of a detection film of the invention shown in Example 1 (front elevational view of hexagonal periphery-fixed structure);

FIG. 9F is a view for explaining the form of a detection film of the invention shown in Example 1 (front elevational view for circular periphery-fixed structure);

FIG. 10A is a view for explaining a reflection type gas detection system of the invention shown in Example 2;

FIG. 10B is a view for explaining a reflection type gas detection system of the invention shown in Example 2 (not exposed to detection gas);

FIG. 11 is a chart showing an example of measurement in which the reflection type gas detection of the invention shown in Example 2 is applied to hydrogen detection:

FIG. 12A is an explanatory view for measuring the reflection type gas detection of the invention shown in Example 2 by the angular displacement of reflection light;

FIG. 12B is an explanatory view for measuring the reflection type gas detection of the invention shown in Example 2 by the angular displacement of reflection light;

FIG. 13A is an explanatory view for reflection type gas detection of the invention shown in Example 2 by use of the change of the optical channel length caused by the positional displacement of a detection film (not exposed to detection gas);

FIG. 13B is an explanatory view for reflection type gas detection of the invention shown in Example 2 by the change of the optical channel length caused by the positional displacement of a detection film (exposed to detection gas);

FIG. 14A is an explanatory view for detecting the change of stress caused by gas adsorption of the invention shown in Example 3 by a piezoelectric element (not exposed detection gas);

FIG. 14B is an explanatory view for detecting the change of stress caused by gas adsorption of the invention shown in Example 3 by a piezoelectric element (exposed to detection gas);

FIG. 15 is a graph showing a measuring example of gas detection using the piezoelectric element of the invention shown in Example 4;

FIG. 16A is an explanatory view for detection of the change of stress caused by gas adsorption of the invention shown in Example 4 by a diaphragm type capacitance element (not exposed to detection gas);

FIG. 16B is an explanatory view for detection of the change of stress caused by gas adsorption of the invention shown in Example 4 by a diaphragm type capacitance element (exposed to detection gas);

FIG. 17 is a graph showing a measuring example of a gas detection using the capacitance element of the invention shown in Example 4;

FIG. 18A is an explanatory view for detection of the change of stress caused by gas adsorption of the invention shown in Example 4 by a shunt type capacitance element (not exposed to detection gas);

FIG. 18B is an explanatory view for detection of the change of stress caused by gas adsorption of the invention shown in Example 4 by a shunt type capacitance element (exposed to detection gas);

FIG. 18C is an explanatory view for detection of the change of stress caused by gas adsorption of the invention shown in Example 4 by a shunt type capacitance element (top view of the shunt type element);

FIG. 19 is a view showing a constitutional example of forming an optical gas detection device of the invention shown in Example 5 on a semiconductor substrate (cantilevered type, with temperature compensation element);

FIG. 20 is a view showing a constitutional example of forming an optical gas detection device of the invention shown in Example 5 on a semiconductor substrate (both end-supported type, with temperature compensation element);

FIG. 21 is a view showing a constitutional example in which an optical gas detection device of the invention shown in Example 5 is arranged as an array on a semiconductor substrate;

FIG. 22 is a view showing a constitutional example of a module in which an optical gas detection device of the invention shown in Example 5 is highly integrated together with a light source and a light detection element on a semiconductor substrate;

FIG. 23 is a view showing a constitutional example of a device conducting gas detection by surface acoustic waves utilizing the detection film and in accordance with the principle of the invention shown in Example 5;

FIG. 24A is a top view showing Example 7 of the invention;

FIG. 24B is a cross sectional view showing Example 7 of the invention;

FIG. 25A is a top view showing Example 8 of the invention;

FIG. 25B is a cross sectional view showing Example 8 of the invention;

FIG. 26A is a top view showing Example 9 of the invention;

FIG. 26B is a cross sectional view showing Example 9 of the invention;

FIG. 27A is a top view showing Example 10 of the invention;

FIG. 27B is a cross sectional view showing Example 10 of the invention;

FIG. 28A is a top view showing Example 11 of the invention;

FIG. 28B is a cross sectional view showing Example 11 of the invention;

FIG. 29A is a top view showing Example 12 of the invention; and

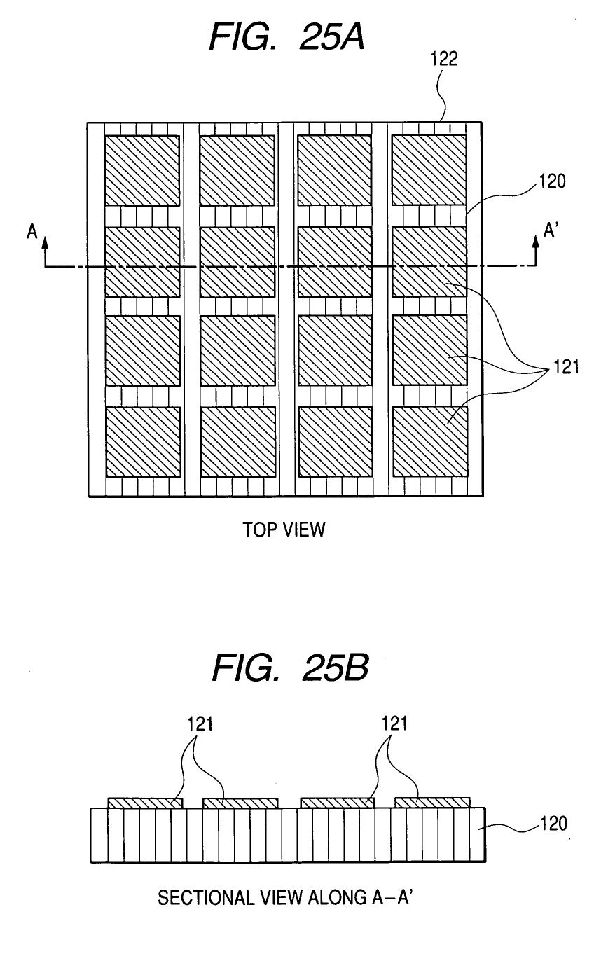

FIG. 25B is a cross sectional view showing Example 12 of the invention;

### DESCRIPTION OF THE PREFERRED EMBODIMENTS

An optical coupling loss accompanying the stress deformation of a detection film caused by gas adsorption is detected by light intensity in a transmission type or reflection type detection device of an optical system in which light from a white light source or a light source with a determined wavelength, for example, LED or LD is guided by way of an optical fiber or a waveguide channel, and is passed through a multi-layered detection film of a cantilevered structure fixed at one end, and an optical fiber on the receiving side is accurately positioned at a counter part. Alternatively, a structure in which a piezoelectric element is bonded to the multi-layered detection film, or a capacitance element structure in which an electrode is opposed to the multi-layered detection film is adopted to detect the change of voltage-current or change of capacitance caused by the occurrence of stress in the detection film due to gas adsorption.

### EXAMPLE 1

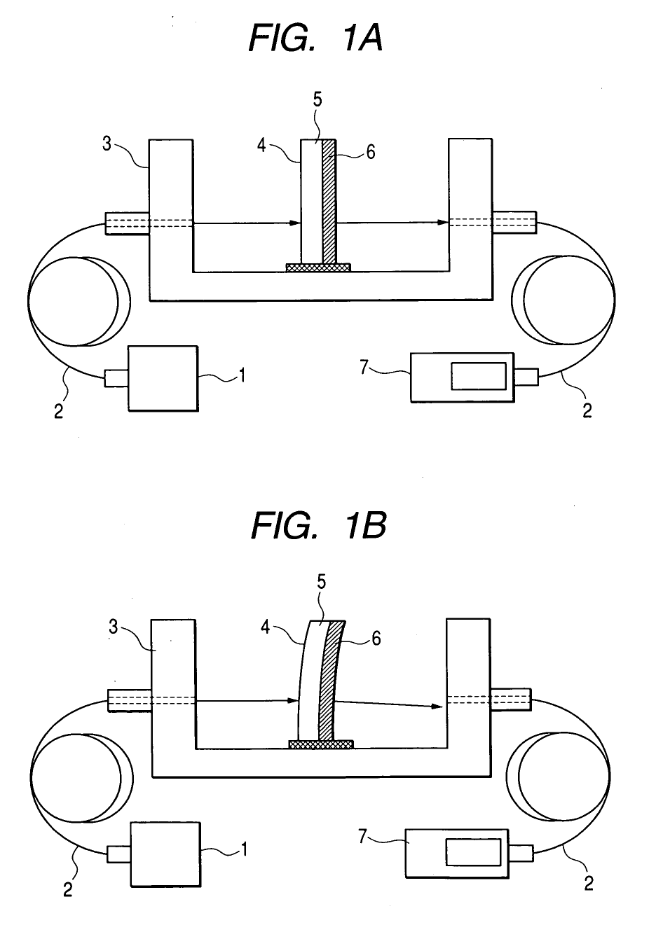

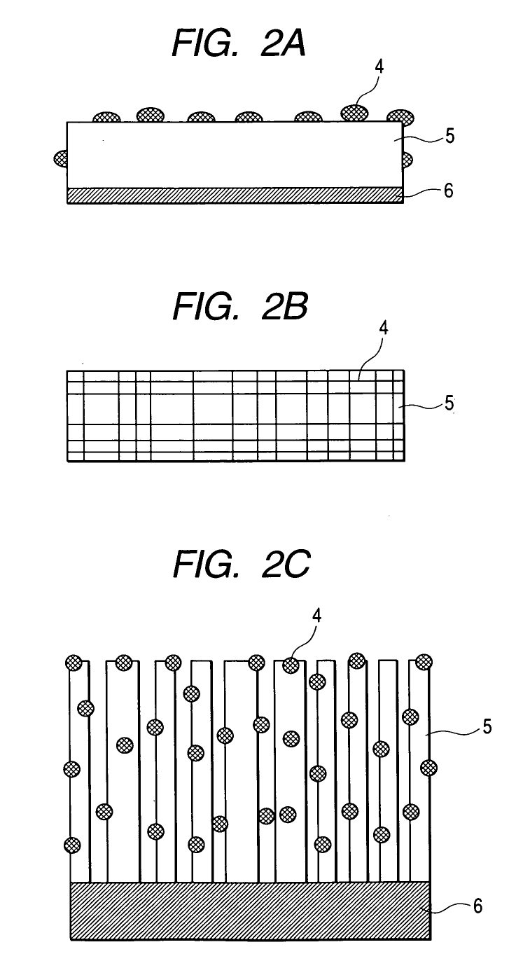

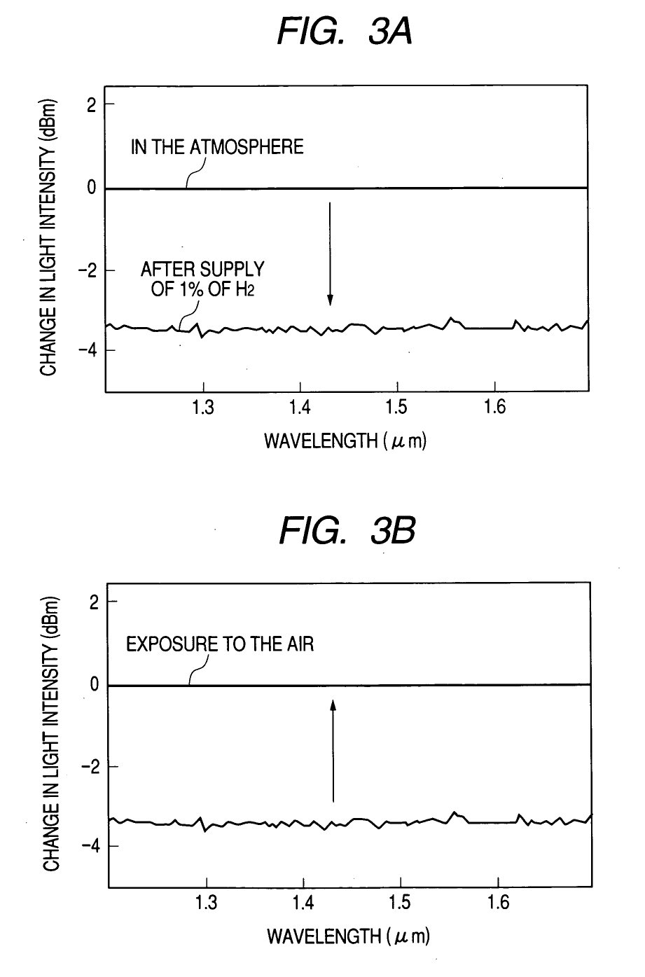

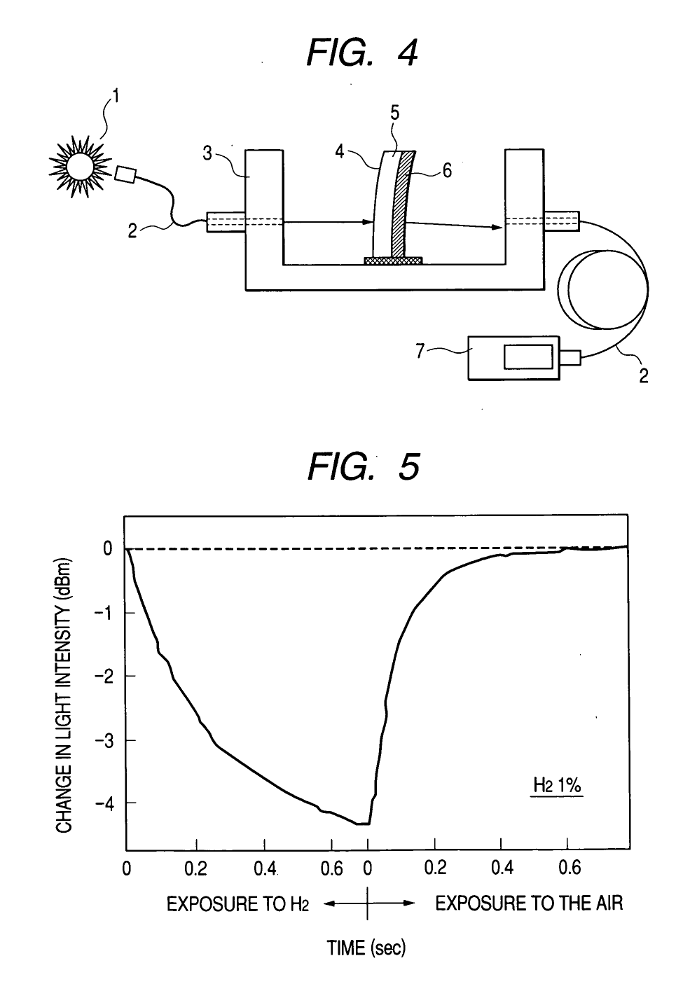

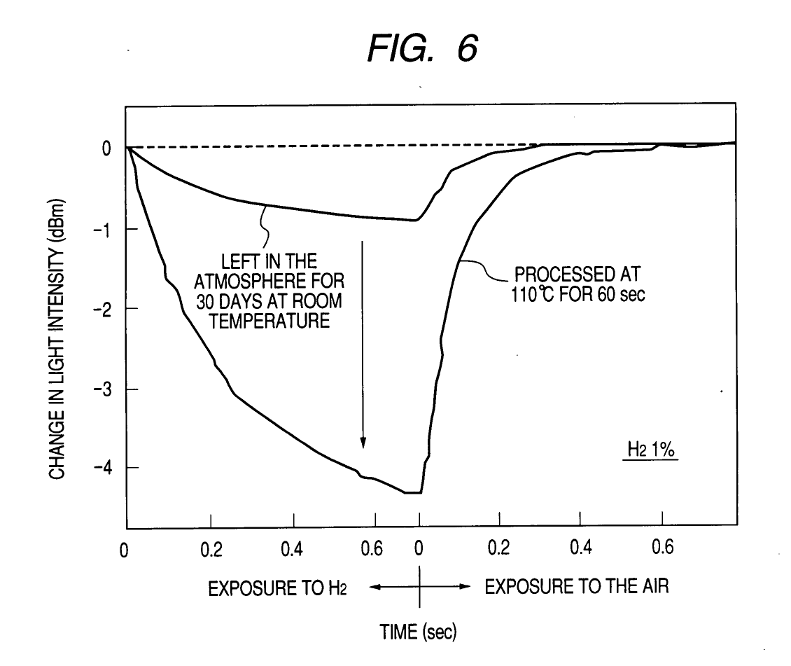

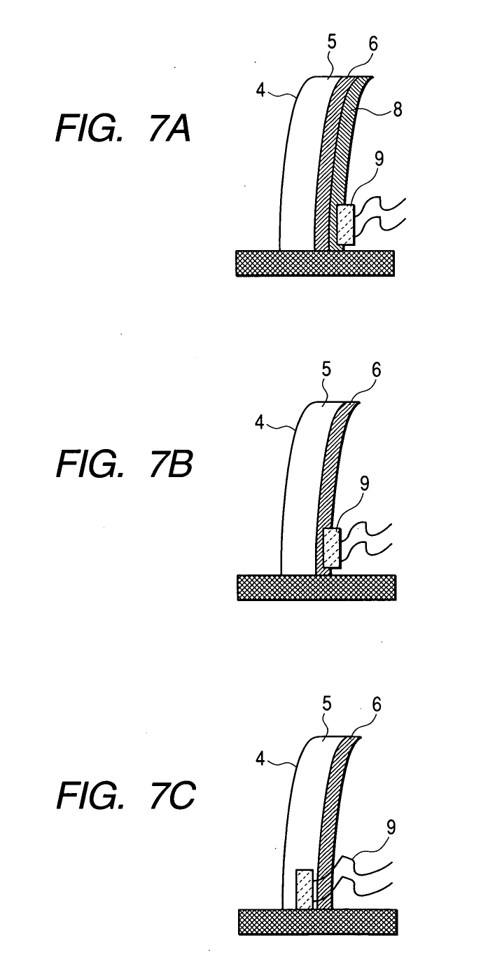

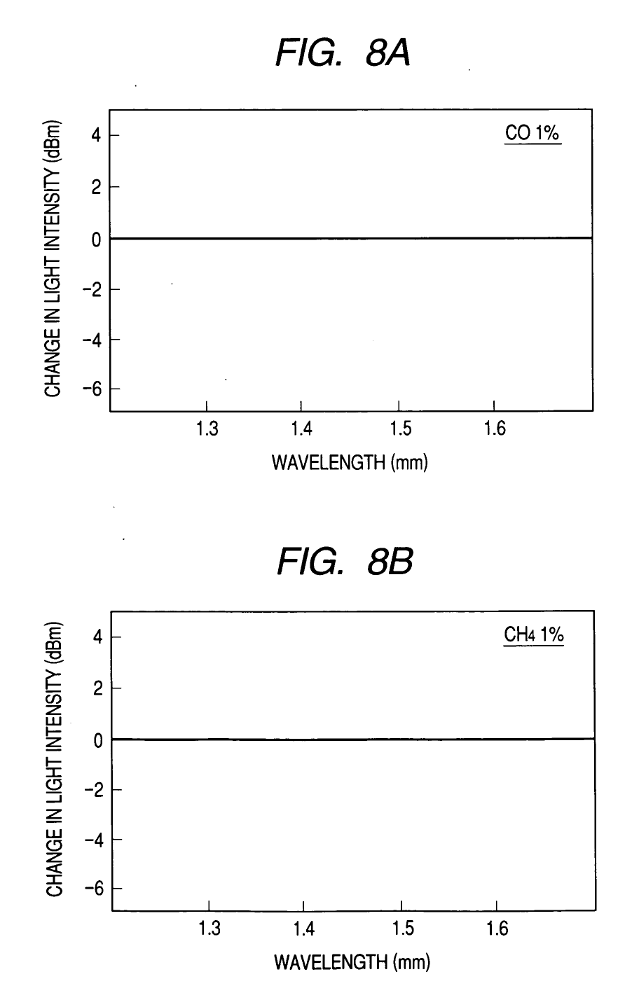

FIGS. 1A and 1B are cross sectional views of a transmission type gas detection device of a cantilevered structure as an example of the present invention. Light to be detected is introduced from a white light source 1 through an optical fiber 2 into the detection apparatus. Reference numeral 3 denotes a U-shaped light detection block having an optical fiber introduction hole or a coupler positioned accurately in which the introduced light to be detected is introduced by way of a detection film into a fiber on the detection side and detected, for example, by a spectrum analyzer, a photooutput meter, a photodiode or the like as the detector 7. The detection film has a multi-layered structure comprising a catalyst film 4 carried in such a structure not hindering gas adsorption, a gas adsorption layer 5 and a support substrate 6. This example has a cantilevered structure fixed at one end to the U-shaped light detection block 3. For the light detection block, the U-shaped configuration is not essential and has no particular restriction so long as it has a structure capable of fixing the detection film and easily detecting the light. The catalyst film of a structure not hindering the gas adsorption referred to herein means, for example, a structure as shown in FIG. 2A to FIG. 2C of supporting in an island shape (cross sectional view in FIG. 2A or mesh-like shape (top view in FIG. 2B) or a structure in which the catalyst is dispersed and deposited at the nano order size in the fine structure of the detection film (cross sectional view of FIG. 2C). In a state where a gas to be detected is not present, since the detection film causes no change, the light permeating the detection film smoothly reaches the detection side (FIG. 1A). However, under the presence of the gas to be detected, a predetermined gas adsorption layer 5 of the detection film causes expansion due to the gas adsorption and a stress is generated relative to the support substrate 6 scarcely causing change to put the detection film of the multi-layered structure in a folded state. Along with the change of shape of the detection film, coupling loss occurs making it difficult for the detection light to reach the detection side thereby remarkably lowering the light intensity (FIG. 1B, FIG. 3A). While FIG. 3 shows the results in a wavelength region from 0.1 μm to 1.8 μm, since the invention does not adopt a system of detecting absorption of light at a specified wavelength, the change in intensity of light with any wavelength can characteristically be detected with no dependence on the wavelength. Thus, it is not necessary to use expensive parts for the light source 1, and inexpensive electric valves or LEDs may be used and, depending on the case, a system not using a light source but utilizing light present in the circumstance (FIG. 4) is also possible, greatly contributing to the reduction of the cost for the detector itself. FIGS. 1 and 3 show the results for the detection of hydrogen gas by using Pd formed by vapor deposition as the catalyst film 4, a WO₃ film of 1.0 μm thick formed by an organic metal CVD as the gas adsorption layer and a glass substrate of 0.2 mm thick as the support substrate. A large change of light intensity of 3 dBm or more is obtained for a hydrogen gas concentration of 1% and it can be seen that this has a sufficient detection performance as a leakage detection sensor for hydrogen having an explosion limit of 4% in atmospheric air. Further, since the detection speed is sufficiently high and it returns to the result before measurement rapidly when returned into air after measurement, it can also be used repetitive (FIG. 5). In a case where it is used at a normal temperature for long time, it sometimes adsorbs gas ingredient in the air, lowering the sensitivity or responsiveness. In addition, it can be restored when the detection film is heated continuously or intermittently to a temperature of as high as 50 to 150° C. (FIG. 6). For the heater for heating the detection film to a high temperature, it may be warmed from the outside of the detector, or may be heated by the irradiation of infrared rays or far infrared rays. However, it is most effective to apply heating, for example, by a thin film heater 8 from the rear face of the detection film as shown in FIG. 7A. Further, a resistor member having a good adhesion with the adsorption detection film 5 and less causing gas adsorption, for example, a metal oxide film or a silicide or nitride film may also be used (FIG. 7B). Alternatively, an electrode 9 may be formed in a gas adsorption detection film 5 as metal oxide and the detection film 5 per se can also be used as the heater (FIG. 7C). Further, reaction is not taken place at all with CH₄ or CO which cannot be distinguished from hydrogen by the usual SnOₓ catalytic semiconductor sensor and the selectivity to the gas to be measured is extremely excellent (FIGS. 8A and 8B). Further, the detection film comprises the laminate or stacked structure of the metal oxide film and glass as a main portion. It has been confirmed that the detection film has excellent interface adhesion, suffers from no peeling from the substrate as observed in existent metal adsorption films, is durable to repetitive operations for 20,000 cycle or more and is highly reliable.

Examples 7 to 12 shows examples for obtaining highly reliable detection films by preventing defoliation between the catalyst and the detection film.

While Example 1 uses a combination of Pd as the catalyst film 4 and Pd/WO₃ as the gas adsorption layer 5, a similar effect can also be obtained by replacing Pd with Pt, Y, La, Pt—Rh, Pt—Pd or Au and replacing WO₃ with V₂O₅ or ZnO. Also for the method of forming the detection film, a similar effect can be expected also by using the detection film formed by various film-forming techniques including sputtering not being limited to vapor deposition or organic metal CVD. In a case of using a Pd/WO₃ system, when WSi₂, WSiN, or the like is used for the support substrate 6 of FIG. 7B, the support substrate 6 itself has a function of a heater to enable more stabilized use of the detection film.

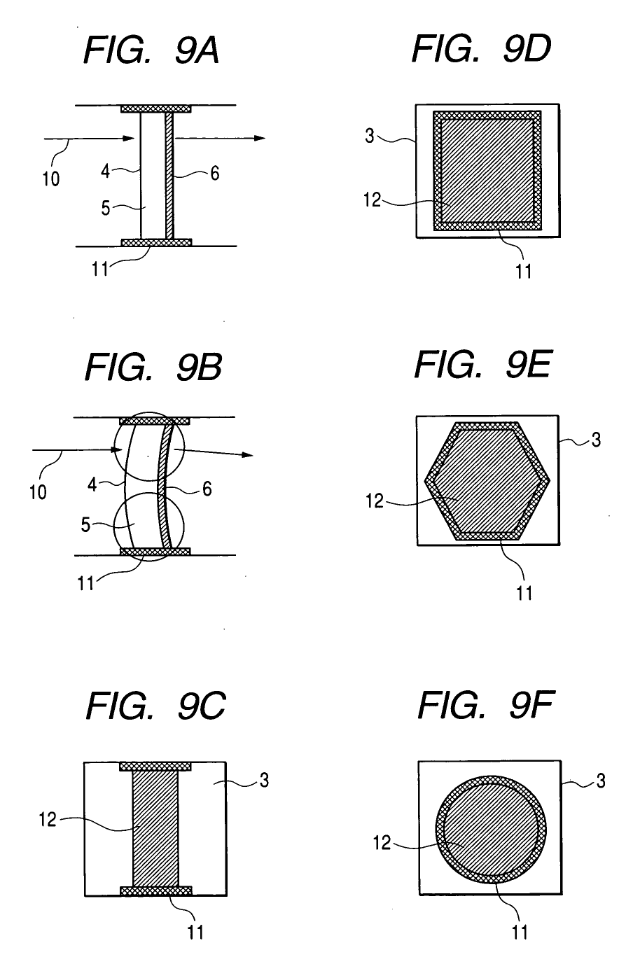

Further, as shown in FIGS. 9A to 9F, the same detection is possible also by detection films not restricted to the cantilevered type but also by a detection film of both end-supported type or those using the periphery of a circular or polygonal shape as the fixed end 11. FIGS. 9A and 9B describe the detection film in a case of the both end-support type and in a case of fixing the periphery of a circular and polygonal shape as a fixed end, and the same detection as that by the cantilevered type is possible by setting the optical channel 10 in a region near the fixed end 11. FIGS. 9C to 9F show the detection film 12 as viewed from the side of introducing light and various forms of detection film structures may be conceivable in addition to the both end supported type (FIG. 9C), as well as a rectangular shape fixed on the periphery (FIG. 9D), a hexagonal shape fixed on the periphery (FIG. 9E) and a circular shape fixed on the periphery (FIG. 9F). A plurality of fixed ends increase the strength against vibrations and the like. When the detection apparatus comprising the circular shape detection film described above was actually mounted on an automobile for detection of hydrogen, the hydrogen concentration as low as 0.05% could be detected with no erroneous operation caused by vibrations.

### EXAMPLE 2

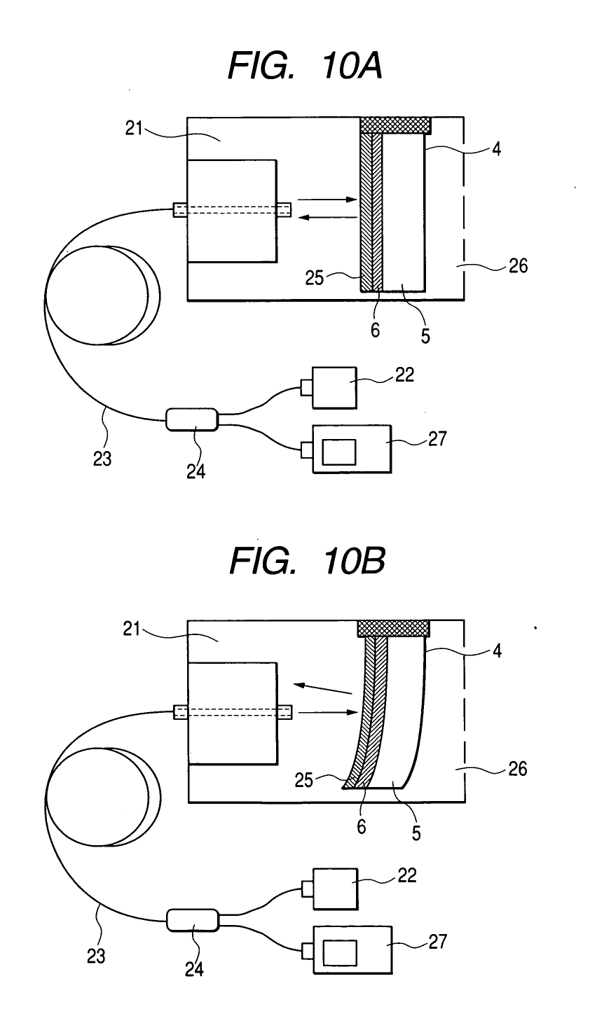

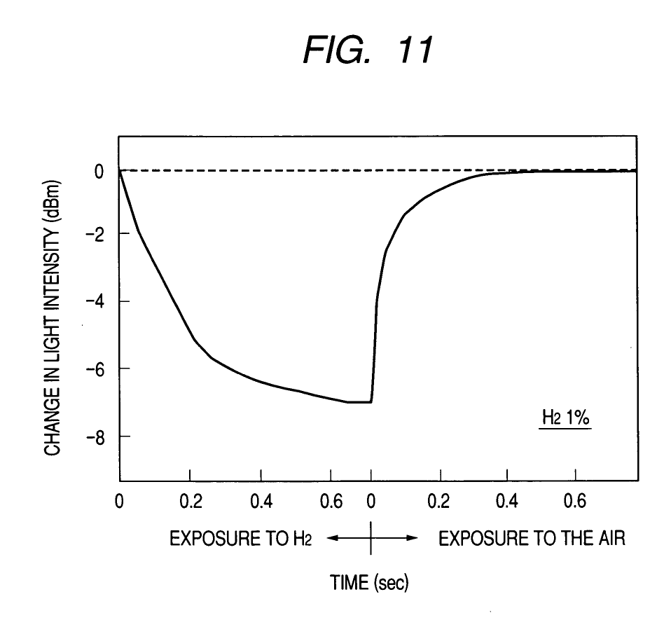

FIGS. 10A and 10B are cross sectional views of the reflection type gas detection apparatus of a cantilevered structure as an example of the invention. This apparatus has a structure in which the incident fiber and a receiving fiber are identical, but incidence and reception of light may be conducted by independent fibers with no particular problems. The detection light emitted from an LED or white light source 22 passes through a fiber 23 and, by way of an optical circulator 24 and then enters from a detection apparatus casing 21 to a detection film in perpendicular thereto. The detection film has a cantilevered structure and is in contact at one fixed end to the detection apparatus casing 21. The detection film comprises, like in Example 1, a catalyst film 4, an adsorption type detection film 5 and a support substrate 6. In a case of the reflection type, it has a structure of further adding a light reflection layer 25 at the rear face of the support substrate. In a state where the gas to be detected is not present, the light incident on the detection film is reflected by the reflection layer 25 on the detection film surface in the same direction as the incident direction and then taken as return light into the fiber 23. The thus taken light is sent by way of the optical circulator 24, and the gas concentration is detected according to the change of the light intensity or the like by a detector 27 such as a spectral analyzer, a light intensity meter or photodiode as shown in FIG. 10A. On the other hand, in a state where the gas to be detected is present, a gas as an object of detection intruding from a detection gas intake port 26 is adsorbed by the gas adsorption film 5, and stresses is generated to cause deformation. Along with the deformation, the light is reflected in the direction different from that of the incident light by the reflection film 25 to cause loss of coupling with the fiber 23 and enable detection by the change of the lighting density. FIG. 11 shows the result of applying this example to the detection of hydrogen with 1% concentration. For the detection film, a Pt—Pd film was formed by vapor deposition as the catalyst film 4, a WO₃ film was formed by organic metal CVD deposited by 1 mm thick on the glass substrate 6 and, further, Al coated at 300 nm as a reflection film 25 on the rear face of the glass substrate 6. Further, an LED light source of 1.56 μm was used for the detection light and the detection light is detected by a light intensity meter 27. For the hydrogen gas with 1% concentration, a change of 5 dBm or more could be obtained and the restoring property after opening to air was also favorable. While Al was used for the reflection film 25, other high reflectance films such as a Ti film and an Ag film may be used. Further, a multi-layered reflection film, a refraction grating or a photonic crystal capable of obtaining reflectance to a specified wavelength may be used.

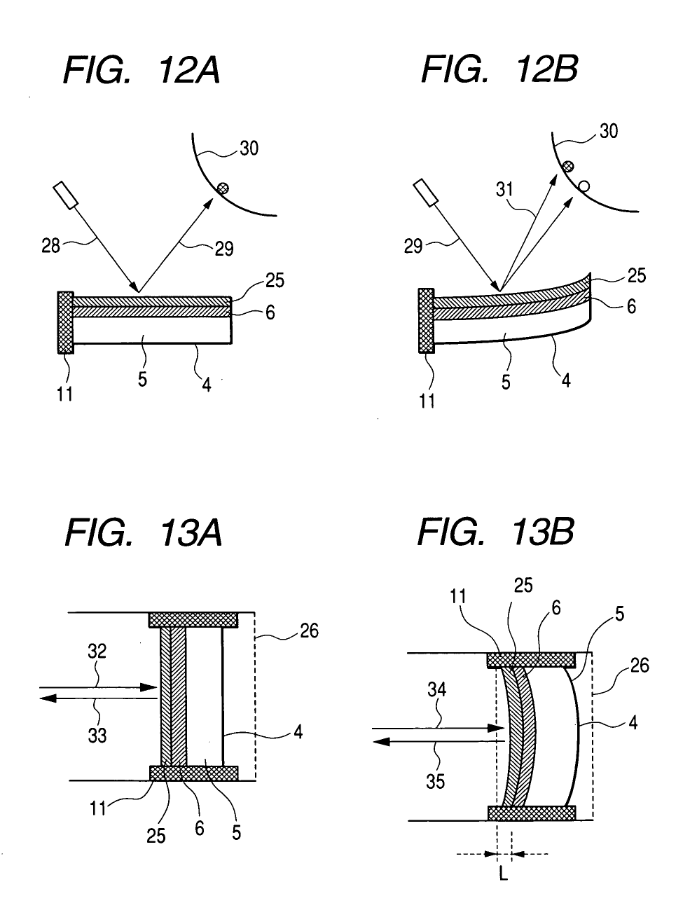

Further, in addition to the method of measuring the reflection light intensity, a method of detecting the stress deformation caused by detection gas in accordance with the angular change of the reflection light as shown in FIGS. 12A and 12B is also effective. FIG. 12A shows a state in which the gas for detection was not present and FIG. 12B shows the state exposed to the detection gas. Further, as shown FIGS. 13A and 13B, it is also possible to detect the moving distance L due to the stress at the central portion of the detection film fixed to the cantilevered beam or at the periphery as the displacement of optical channel length 21. FIGS. 13A and 13B show the state where the detection gas is not present and a state where it is exposed to the detection gas, respectively.

### EXAMPLE 3

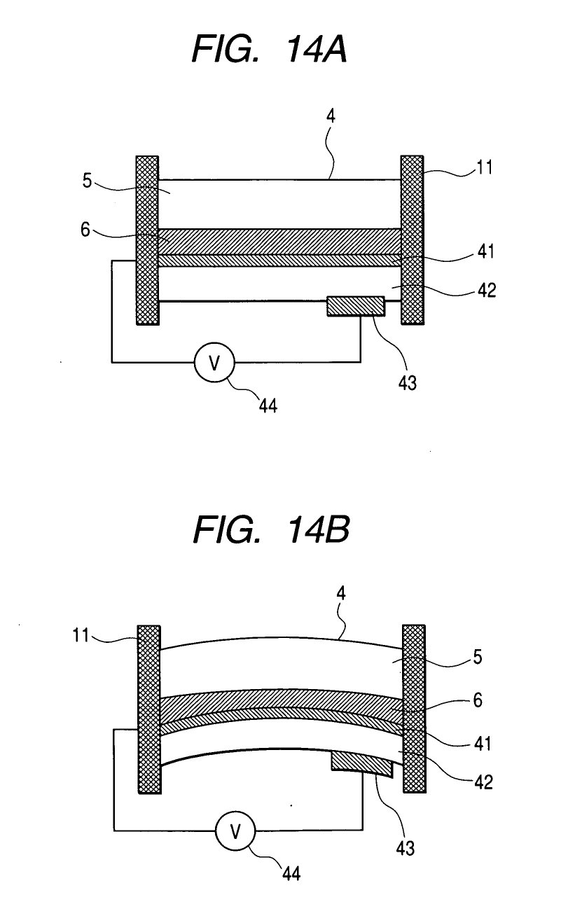

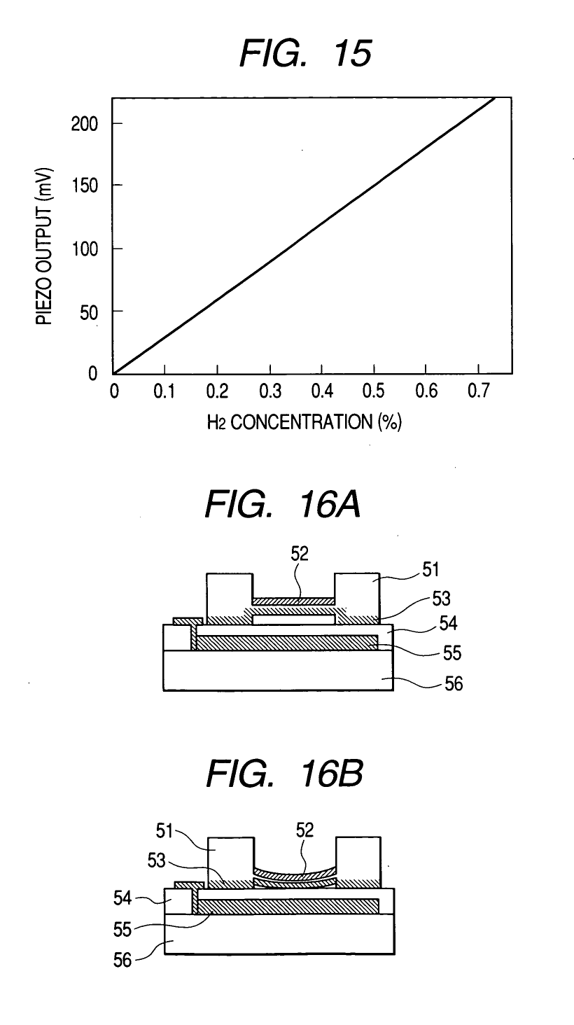

FIGS. 14A and 14B are cross sectional views of a stress type gas detection apparatus utilizing a piezoelectric element as Example 3 of the invention. The detection film is composed of a multi-layered structure comprising a catalyst film 4, an adsorption type detection film 5, and a support substrate 6 like in Examples 1 and 2, and, for stress detection, a piezoelectric element comprising an upper electrode 41, a piezoelectric film 42 and a lower electrode 43 is further attached to the rear face of the support substrate 6. In a state where the detection gas is not present, the stress is not generated as shown in FIG. 13A, so that the piezoelectric element produces no output. In a state where the detection gas is present, since the gas is adsorbed to the detection film to cause expansion, this results in stress in the multi-layered film, generating an electromotive force from the piezoelectric element. The gas can be detected by measuring the voltage between the first electrode 41 and the second electrode 43 by a potential meter. For example, FIG. 15 shows the result of detecting the concentration of a hydrogen gas by a piezoelectric element constituted by using a Pd film (15 nm) by vapor deposition as the catalyst film 4, a WO₃ film (750 nm) by a sputtering as the detection film 5 and a detection film using an Si (100) substrate of 300 μm as the support substrate and using a piezoelectric element constituted with a first electrode 41 made of Pt—Ti, a piezoelectric material film 42 made of PZT (plumbic zirconate titanate), and a second electrode 13 made of Pt. The detection film used herein has a area of 9 mm×9 mm. FIG. 15 shows that detection can be conducted as far as a low concentration with good linearity. Further, while PZT was used as the piezoelectric material film 42 in this case, a similar effect can be expected also for those having a piezoelectric effect such as a barium or polymeric piezoelectric film.

### EXAMPLE 4

FIGS. 16A and 16B are cross sectional views of a stress detection type gas detection apparatus utilizing static capacitance detection as an example of the invention. It has a diaphragm structure of 5 μm thick obtained by fabricating an Si substrate (100) 51, in which a dielectric film 54 is put between the substrate and a metal electrode 55 as a capacitor. The gap between the diaphragm and the dielectric film 54 is 3 μm and they are stacked above a glass substrate 56. A Pd/WO₃ detection film 52 that generates stress by adsorption of hydrogen is deposited on the substrate 51. When they are placed in a hydrogen atmosphere, a diaphragm is deformed by the stress of the detection film and brought into contact with the dielectric film 54. Consequently, the hydrogen concentration can be measured by the change of the capacitance value.

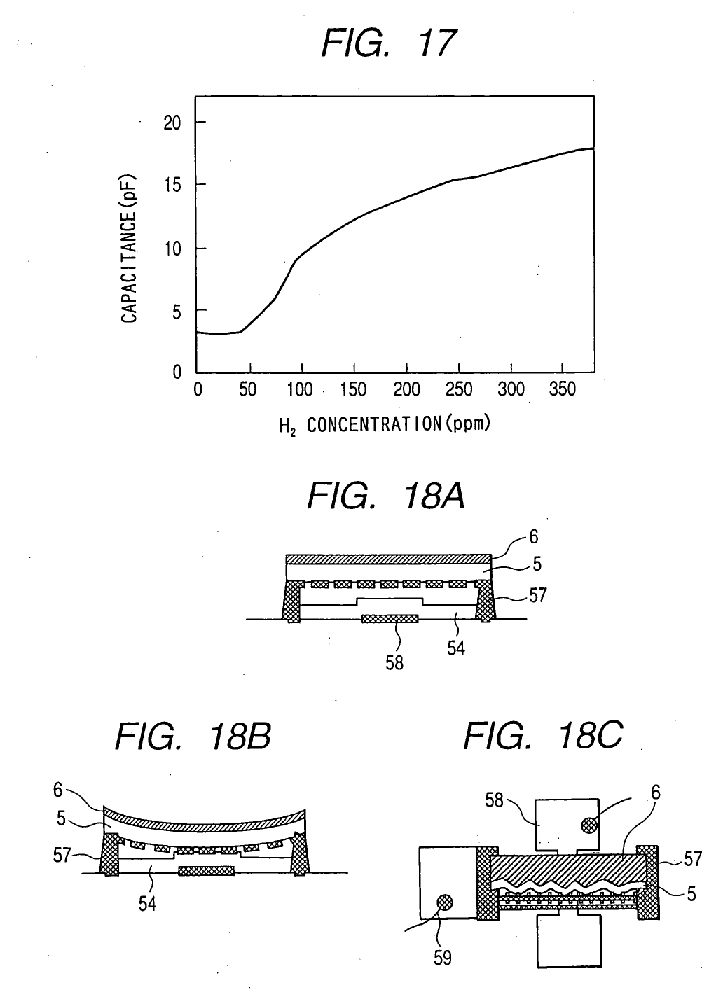

FIG. 17 shows a relation between the hydrogen concentration and the capacitance value for a detection film area of 0.3 mm×0.6 mm. Detection with high sensitivity is possible for a hydrogen concentration of as low as about 50 to 100 ppm and, in addition, the sensor main body can also be mounted to portable equipment since the device can be easily reduced in the size. The capacitance detection is possible not only in the diaphragm structure but also in a shunt structure.

For example, FIG. 18 is a MEMS stress detection capacitance type gas detection apparatus using a WO₃ film formed by organo metal CVD as a hydrogen detection film 5, and an SiO₂ support film 6 formed by thermal CVD, a catalyst film and top electrode 57 sized 1.5 μm×3.0 μm is formed as a mesh structure of Pt and Pd and a dielectric film 54 is used between the detection film and the lower electrode 58. By the reduction in the size of the device, detection with a high sensitivity of 1 ppm to 50 ppm is possible. FIGS. 18A and 18B are views for the cross sectional structure before and after hydrogen exposure and FIG. 18C is a top view.

Since the detection apparatus illustrated herein can be easily reduced in size and has a strong structure against vibrations being fixed on the periphery, it is particularly suitable to application uses, for example, in automobile mounting or portable equipment.

### EXAMPLE 5

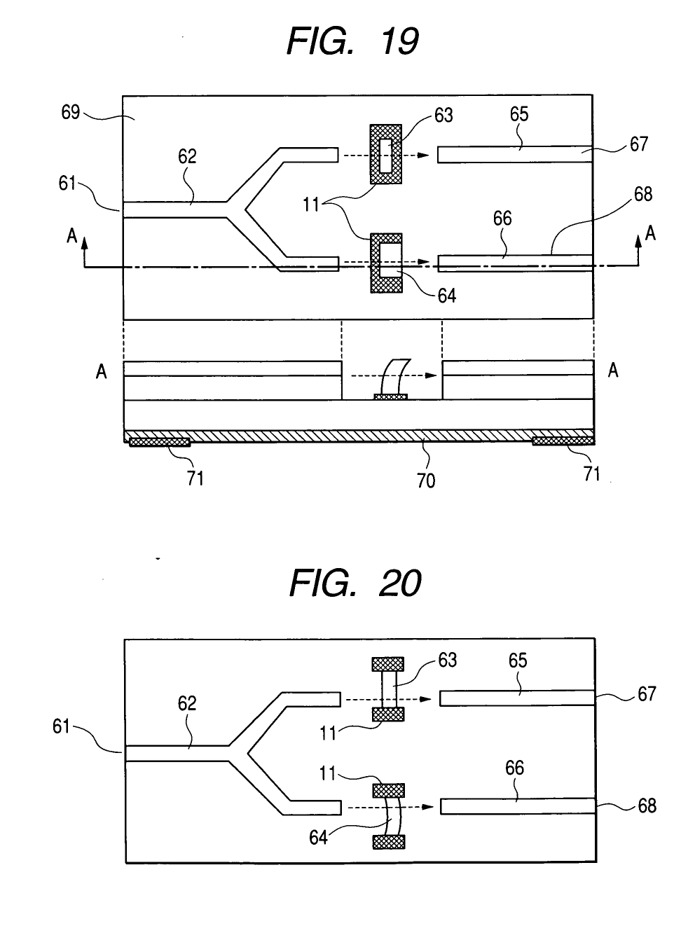

FIG. 19 is an example of mounting an optical stress detection type gas detecting apparatus provided with a temperature reference device according to the invention on a semiconductor substrate. On a semiconductor substrate 69, for example, made of Si, GaAs or InP, waveguide channel input 62 and outputs 65, 66 are formed, between which a detection film 63 for temperature reference and a gas detecting detection film 64 for gas detection are disposed and they measure the light intensity simultaneously. The temperature referred detection film 63 has the same specification as the detection film 64 in view of the structure of the detection film excepting that the catalyst film is not supported on the gas detection film. Since the catalyst film is not present, gas adsorption does not occur and the stress on the temperature reference detection film 63 is that caused by the change of temperature. Accordingly, the difference of the light intensity between the change of the light intensity measured by the gas detection film 64 and the light intensity measured by the temperature reference detection film 63 constitutes an actually detection gas concentration. FIG. 19 shows a device of providing a thin film heater 70 at the rear face of the semiconductor substrate 69, and it can be used stably for a long time by the heater and, in addition, detection with higher accuracy is possible by keeping the temperature constant. Actually, when utilizing InP for the semiconductor substrate 69, an InP series multi-layered structure as waveguide channels 62, 65, and 66, a multi-layered structure film of WO₃/SiO₂ with 1.5 μm wide and 3.0 μm long as the temperature reference detection film 63 and a multi-layered structure film of Pd/WO₃/SiO₂ of 1.5 μm wide and 3.0 μm long as the gas detection film 64 and introducing an infrared light source 60 at a wavelength of 1.55 μm, a hydrogen concentration of 10 ppm to 1% could be measured with an accuracy of ±0.1% when the hydrogen concentration was detected by light intensity meters 67 and 68.

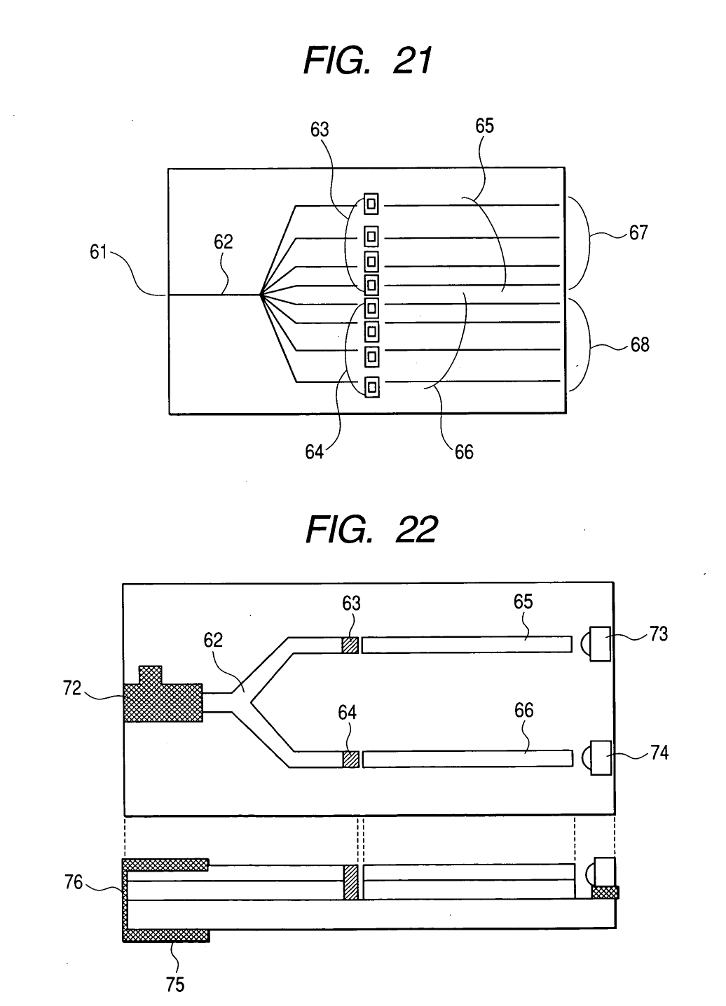

While the description has been made of the detection film of the cantilevered structure in this example, a similar effect can also be obtained, for example, by the both end-supported type structure as shown in FIG. 20. Further, a device having a multi-channel structure as shown in FIG. 21 is also possible. A large dynamic range can be attained by changing the size of the detection film or the length of the support substrate and, in addition, gases of polynary components series can also be detected simultaneously by hybridizing detection films corresponding to a variety species of gases. Further, as shown in FIG. 22, a highly integrated gas detection module of hybridizing a semiconductor laser 72 and photodiodes 73, 74 and depositing a temperature control detection film 63 and a gas detection film 64 at the end faces of the waveguides can be attained easily. For example, when using a distribution feedback type 1.3 μm laser diode as a light source 71, WO₃/Si₃N₄ as the temperature reference detection film 63 and Pd—Pt/WO₃/Si₃N₄ as the gas detection film 64, for the detection of hydrogen concentration, detection with a high sensitivity of 100 ppm to 0.5% (±0.05%) and detection with high accuracy are possible. Further, when NO₂ was detected by utilizing the same light source using TiO₂/SiO₂ as the temperature reference detection film 63 and Pt—Rh/TiO₂/SiO₂ as the gas detection film 64, detection with a high sensitivity of 5 ppm to 0.5% (±0.05%) and detection with high accuracy can also be conducted. Like Example 4, the detection device can also be reduced in size and it has a structure capable of easily canceling low frequency vibrations generated when mounted on vehicles or portable equipment.

The gas detection method and the detection device according to the invention detect the occurrence of stress to the multi-layered film caused by the adsorption of a specified gas and it can operate basically with no power supply. Accordingly, unlike the semiconductor sensor utilizing the catalytic action, since various optical changes such as caused by deformation of the film by the stress is changed, the device can operate at a normal temperature and can be put to an operable state so long as the light source and the light detection section, or the stress detection device section are in the detectable state. This facilitates gas leakage detection upon starting which was impossible in the existent semiconductor gas detector and, for example, the safety upon starting a fuel cell automobile utilizing hydrogen can be improved further. Further, in a case of optical detection, a complete explosion proof structure can be obtained easily and this enables use as the densitometer for process control, which was the difficult application use so far. Further, by adopting a detection film that adsorbs only a specified gas, it has an extremely high gas selectivity and only the gas component intended to be measured can be detected with high accuracy even under a circumstance where various gases are present in admixture.

Further, concentration as low as from several ppm which could not be detected so far by the method of optically detecting the absorption at a predetermined wavelength of a reaction product due to gas adsorption is now enabled by optimizing the thicknesses of the gas adsorption layer and the substrate layer. However, since the detection devices can be integrated at a high density on a semiconductor substrate, the detection device itself can be made smaller in size and reduced in weight and can be mounted easily to portable equipment. However, in the case of the optical detection system, since the light source is not limited to a specified wavelength, detection with higher sensitivity can be attained at a reduced cost and, in addition, a light source may be saved depending on the constitution of the device.

### EXAMPLE 6 >

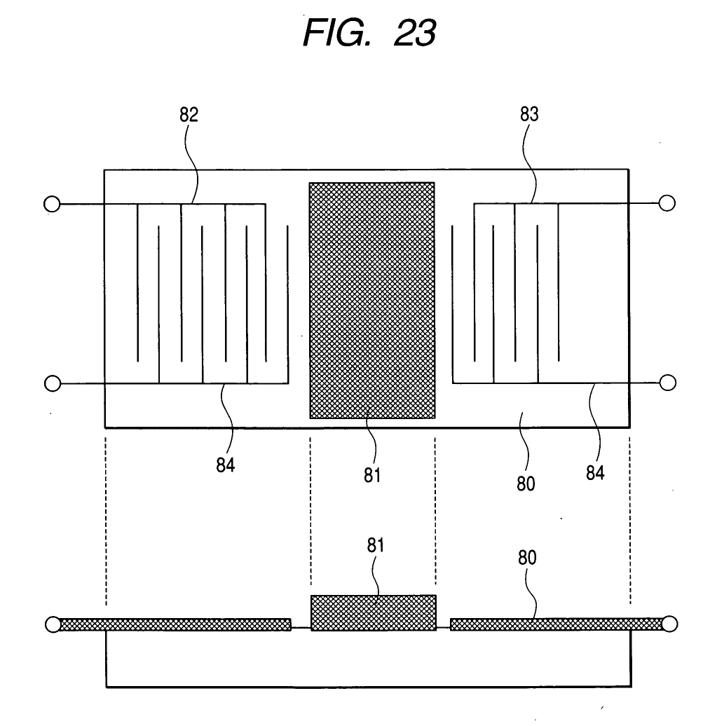

FIG. 23 is an example of gas detection utilizing a surface acoustic wave by using a detection film of the invention. It has a structure of depositing a detection film 81 that adsorbs hydrogen such as made of Pb/WO₃ on a substrate 80 comprising a material having a piezoelectric effect, for example, quartz and, further, disposing IDT (inter digital) electrode input part 82 and output part 83, and ground electrodes 84. When a high frequency wave is inputted between the input electrode 82 and the ground electrode 84, a surface acoustic weave is generated and a signal is taken out by way of the detection film 81 at the output electrode 83 and the ground electrode 84. In this case, when a detection gas is adsorbed on the detection film to cause the change of stress, since the propagation velocity of the surface acoustic wave changes, the frequency changes correspondingly. Detection with an extremely high sensitivity is possible by measuring the frequency change.

When a detection device was actually prepared by using a quartz substrate and a WO₃—CVD film of 1 μm thick carrying Pd as the detection film and a high frequency with several hundreds MHz was applied thereto, measurement with a super-high sensitivity of 0.01 ppm or higher was possible for a hydrogen gas. While an example of piezoelectric plate material (quartz) is shown in this example, for example, the piezoelectric material and the shape thereof have no particular restriction and piezoelectric material other than quartz may be used and any of shape such as circular or spherical shapes may also be adopted. Also for the detection film and the detection gas, any combination may be used so long as a similar effect can be obtained.

### EXAMPLE 7

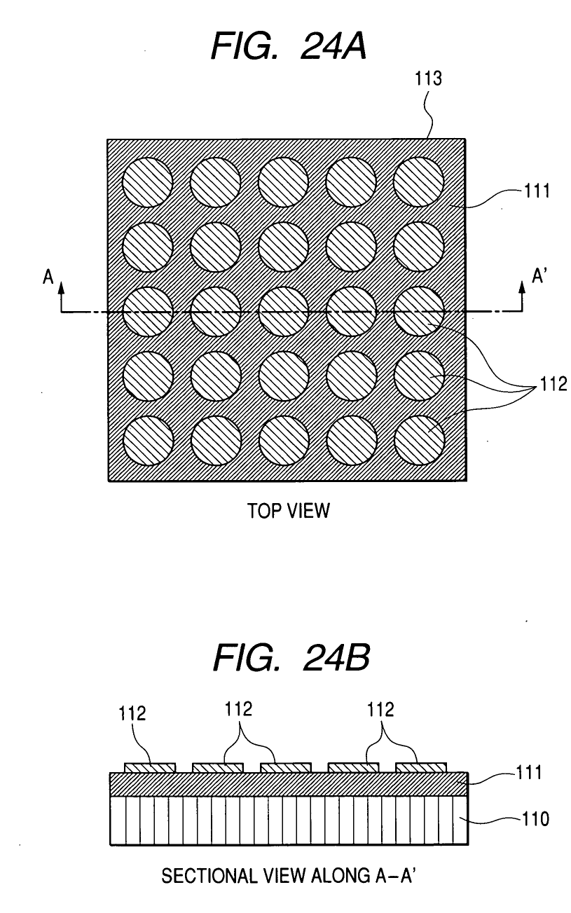

FIG. 24 shows an example of a hydrogen detection device having a dual layered structure of catalyst film/metal oxide according to the invention.

A tungsten oxide film 111 of 500 nm thickness was deposited on a glass substrate 110 by well-known high frequency magnetron sputtering.

Openings each having a resist pattern of 20 μmφ were formed at plural positions over the entire surface of the substrate 110 by using photolithography, a palladium film of 50 nm thickness was deposited by using well-known vacuum vapor deposition, then unnecessary resist pattern and palladium film were removed by lift off, and palladium patterns 112 each having a size of 20 μmφ was formed to complete a hydrogen detection device 113.

When the hydrogen exposure experiment described above (hydrogen concentration in hydrogen containing air: 1%) was conducted to the completed hydrogen detection device 113 for 100 times repetitively and then the surface of the catalyst film palladium pattern 12 was measured and observed, no deterioration in the shape such as surface roughening or film peeling was not observed at all.

In this case, when light at a wavelength of 1.2 μm was irradiated at the same time from the surface to the substrate to observe the change of amount of transmission light, it could be confirmed that the transmission light decayed just after exposure to the hydrogen containing air and it decayed after about ten sec to ½ for the amount of transmission light before exposure. Further, with respect to the amount of the transmission decayed, it could also be confirmed that substantially identical characteristics were obtained also at 100th hydrogen exposure with those at the first exposure.

Further, while preparation of the device has been described to the case of using tungsten oxide and palladium in this example, also in the hydrogen exposure experiment for each of the combinations of using vanadium oxide or molybdenum oxide as the metal oxide and platinum as the catalyst metal, deterioration of the shape did not occur in each of the catalyst metal films.

### EXAMPLE 8

FIG. 25 shows an example of another hydrogen detection device using a single layer of catalyst film according to the invention.

Openings each having a resist pattern of 50 μm square were formed on a glass substrate 120 at plural positions at a maximum distance of 30 μm over the entire surface of the substrate 120 by using photolithography, a palladium film of 80 nm thickness was deposited by using well-known vacuum deposition, then unnecessary resist patterns and palladium film were removed by lift-off and palladium patterns 121 each having a size of 50 μm square were formed to complete a hydrogen detection device 122.

When the same hydrogen exposure experiment (hydrogen concentration in hydrogen containing air: 5%) as in Example 7 was conducted to the complete hydrogen detection device 122 and the surface of the palladium pattern 121 was measured and observed, film peeling was not observed at all while surface roughness occurred to some extent.

In this case, when light at a wavelength of 720 nm was irradiated at the same time from the surface to the substrate to observe the change of the amount of reflection light, it could be confirmed that the amount of reflection light decayed about 2 sec after the exposure to the hydrogen containing air. It was confirmed that the reflection light was decayed 20 sec after as low as ⅓ for the amount of reflection light before exposure.

While the use of the palladium film has been described in this example, when the hydrogen exposure experiment is conducted by using the platinum film, deterioration in the shape of the film such as film peeling was not observed.

### EXAMPLE 9

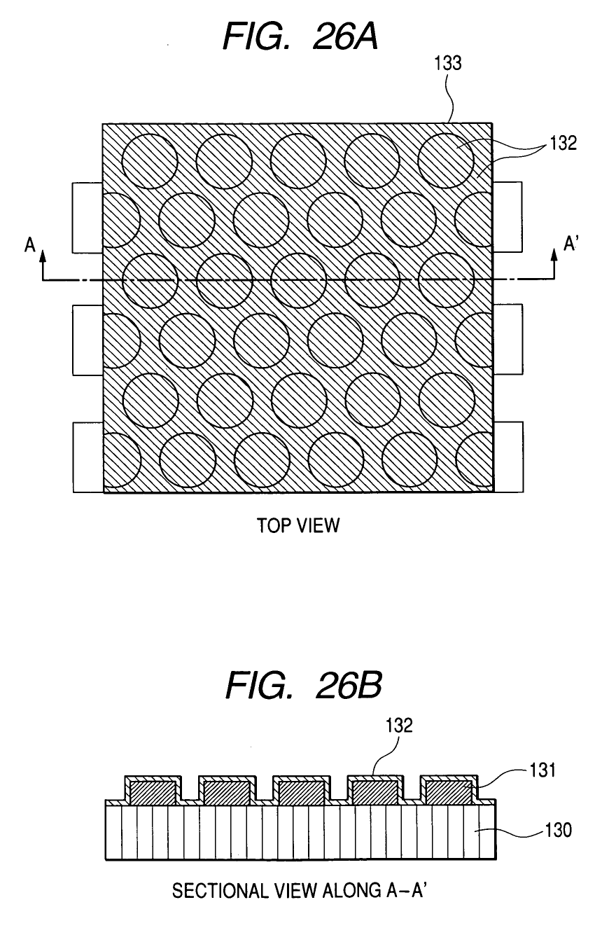

FIG. 26 shows an example of a hydrogen detection device of the invention having a special structure in which a dual layered structure region of catalyst film/metal oxide and a single film region of catalyst film are present in admixture.

Openings each comprising a resist pattern of 30 μmφ were formed at plural positions on a glass substrate 130 each at 50 μm distance over the entire surface of the glass substrate 130 by using photolithography, a vanadium film of 100 nm thickness was deposited by well-known vacuum deposition and then unnecessary resist pattern and vanadium film were removed by lift-off.

A number of vanadium oxide patterns 131 each having a size of 30 μmφ were formed on the glass substrate 130 by applying a heat treatment at about 600° C. in an oxygen atmosphere.

In this stage, convex portions of the vanadium oxide patterns 131 as shown in FIG. 26B were formed at the cross section of the vanadium oxide film 131 shown by broken line A-A′ and, when the film thickness of the vanadium oxide pattern 131 was measured, it was confirmed to be about 250 nm.

A platinum film 132 of 30 nm thickness was deposited over the entire surface of the substrate 130 by using well-known vacuum vapor deposition, to complete a hydrogen detection device 133, in which the dual layered structure region of catalyst film/metal oxide and the single film region of the catalyst film were present together.

As the feature of the hydrogen detection device of the invention described above, since the single film region of catalyst film having excellent high speed response and a dual layered structural region of the catalyst film/metal oxide capable of detection at low concentration are present in admixture, the hydrogen detection device is applicable in the case of requiring detection of hydrogen from low to high concentration region with no restriction for the range of application such as detection place.

### EXAMPLE 10

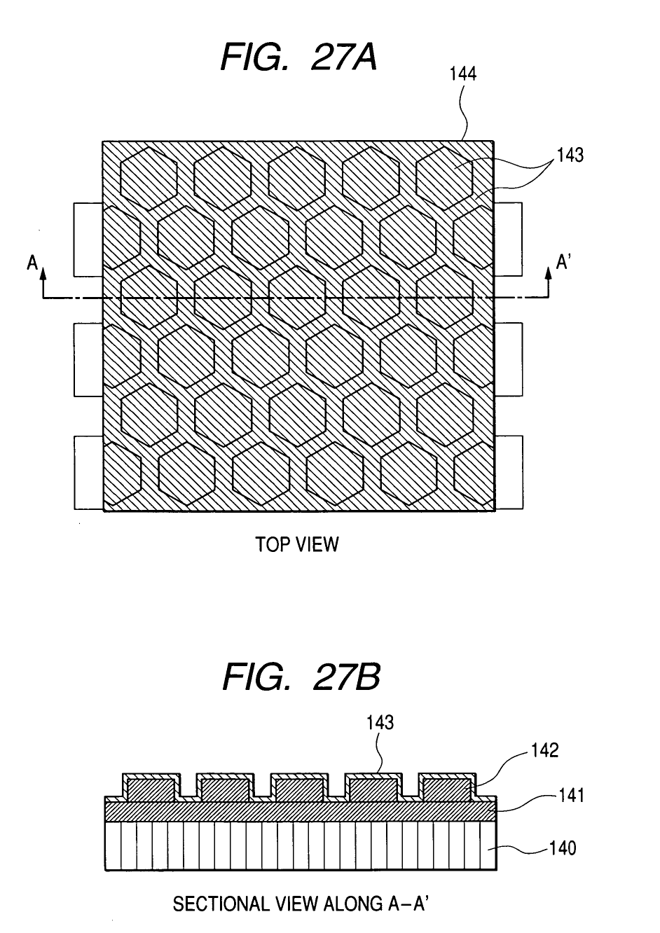

FIG. 27 shows an example of a hydrogen detection device having a special concave/convex shape based on a dual layered structure of catalyst film/metal oxide according to the invention. After depositing a molybdenum film of 100 nm thickness by using vacuum vapor deposition on a glass substrate 140, a molybdenum oxide film 141 was formed over the entire surface of the glass substrate 140 by applying a heat treatment at about 650° C. in usual air. When the thickness of the molybdenum oxide film 141 was measured, it was confirmed that the thickness was about 250 nm.

Openings each comprising a normal hexagonal resist pattern having a diagonal length of 20 μm were formed each at a maximum 20 μm distance by using photolithography.

After depositing a molybdenum film of 100 μm thickness by using vacuum vapor deposition, unnecessary resist pattern and molybdenum film were removed by lift-off to form molybdenum patterns each of a normal hexagonal shape having a diagonal length of 20 μm.

Normal hexagonal molybdenum oxide patterns 142 bonded with the molybdenum oxide film 141 were formed by applying a heat treatment at about 650° C. in air again.

In this stage, concave/convex portions of the molybdenum oxide film were formed as shown in FIG. 27B at the cross section of a region shown along broken line B-B′ where the molybdenum oxide film 141 and the normal hexagonal molybdenum patterns 142 are stacked.

Then, a palladium film 143 of 10 nm thickness was deposited over the entire surface of the substrate 140 by using well known vacuum vapor deposition to complete another hydrogen detection device 144 having a special structure.

In the hydrogen detection device according to the invention, since the dual layered structural region of catalyst film/metal oxide as the hydrogen detection region is formed also on the lateral side of the normal hexagonal molybdenum oxide pattern 142, the area of the detection portion is enlarged and the detection sensitivity and the response speed are further improved compared with usual planar hydrogen detection device prepared on a transparent substrate of an identical size.

A hydrogen exposure experiment (three hydrogen concentrations in hydrogen containing air of 0.2%, 0.5%, and 1%) was conducted while irradiating with light at a wavelength of 1.2 μm the completed hydrogen detection device 144 from the surface of the substrate and the change of the amount of the transmission light was observed. As a result, it could be confirmed that the transmission light decayed from just after exposure to the hydrogen containing air. Further, it was also confirmed that the amount of decay of the transmission light at each of the hydrogen concentration was increased also in proportion as the concentration was higher.

### EXAMPLE 11

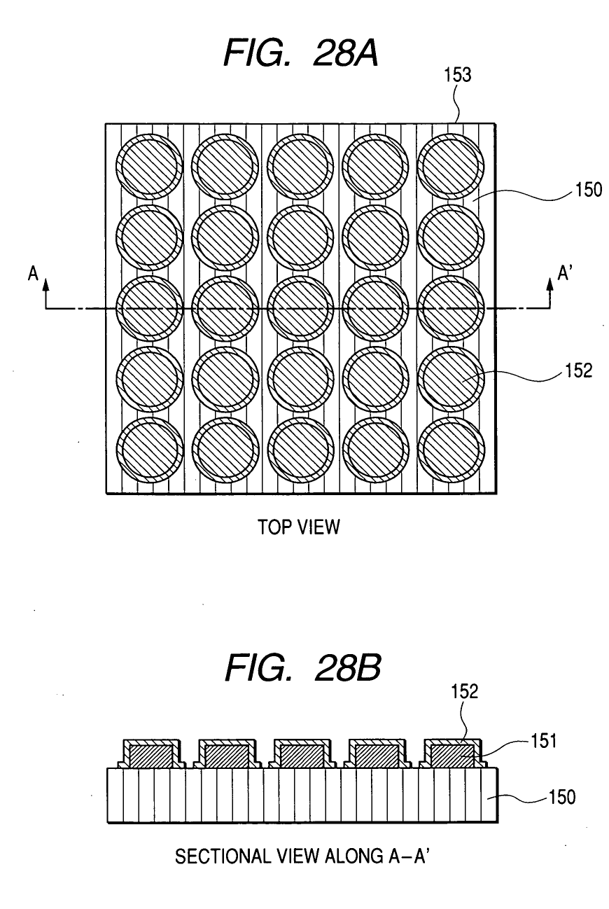

FIG. 28 shows an example of another hydrogen detection device having a special structure in which a dual layered structural region of catalyst film/metal oxide, a single layer region of catalyst film and a region where a glass substrate is exposed are present together according to the invention.

Openings each comprising a resist pattern of 30 μmφ were formed at plural positions on a glass substrate 150 each at a maximum 30 μm distance over the entire surface of the glass substrate 150 by using photolithography, a tungsten film of 50 nm thickness was deposited by using well-known vacuum vapor deposition and then unnecessary resist pattern and tungsten film were removed by lift-off.

Plural tungsten oxide patterns 151 each having a size of 30 μmφ were formed on the glass substrate 150 by applying a heat treatment at about 500° C. in an oxygen atmosphere.

Openings each comprising a resist pattern of 40 μmφ radially larger by 5 μm than the previously formed circular tungsten oxide film pattern 151 were formed to the outer periphery of each tungsten oxide pattern 151 on the glass substrate 150 by using photolithography.

After depositing platinum film of 20 nm thickness by using well-known vacuum vapor deposition, unnecessary resist pattern and platinum film are removed by lift-off, and palladium pattern 152 were formed, to complete a hydrogen detection device 153 in which the dual layered structural region of catalyst film/metal oxide, the single layer region of catalyst film and a region where the surface of the glass substrate was exposed were present together.

It was confirmed that the device 153 also showed satisfactory hydrogen response characteristics like examples described previously.

### EXAMPLE 12

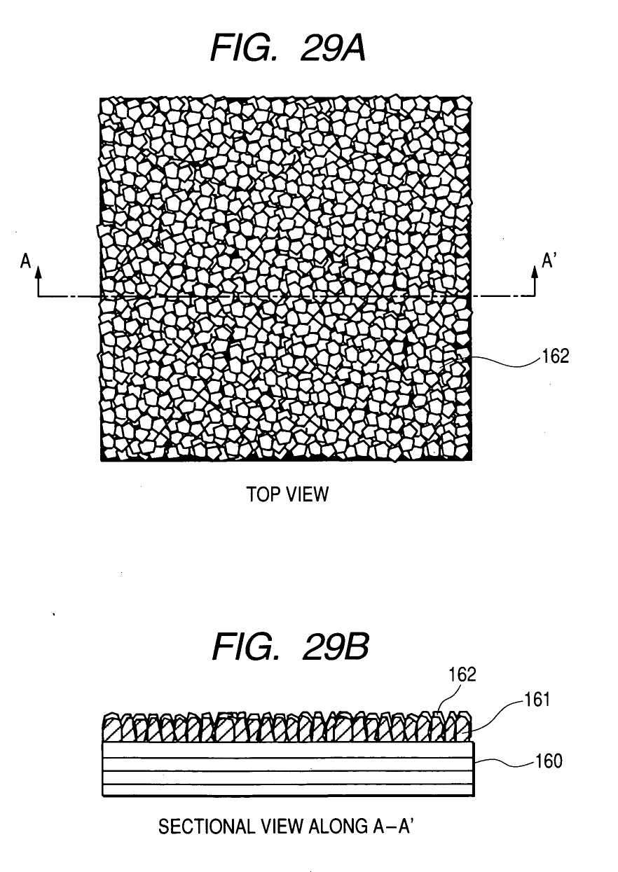

FIG. 29 shows an example of other hydrogen detection device having a structure in which a metal oxide formed on a glass substrate comprises fine crystal particles and a catalyst film is deposited and formed over the entire upper surface thereof.

Tungsten oxide crystal particles each with a size of 0.1 to 5 μm were deposited on a glass substrate 160 to form a tungsten oxide layer 161 having fine concave/convex portions and a space between each of the crystal particles. The forming method can includes, for example, a method of coating an organic solvent containing tungsten oxide crystal particles and then applying annealing at about 400° C. in a nitrogen atmosphere.

Then, a palladium film 162 of 20 nm thickness was deposited over the entire surface of the substrate by using well-known vacuum vapor deposition to complete a hydrogen detection device 163 of a dual layered structure of catalyst film/metal oxide, in which tungsten oxide as the metal oxide comprised fine crystal particles.

In the hydrogen detection device 163 according to the invention, since the dual layered structural region of catalyst film/metal oxide as the hydrogen response region had an extremely large area, the detection sensitivity and response speed were improved remarkably compared with usual planar hydrogen detection devices manufactured on a transparent substrate of an identical size.

A hydrogen exposure experiment (hydrogen concentration in hydrogen containing air: 0.5%) was conducted while irradiating with light at a wavelength of 1.2 μm the completed hydrogen detection device 163 from the surface to the substrate and, when the change in the amount of transmission light and the amount of reflection light was observed, it was confirmed that the transmission light and the reflection light decayed abruptly from just after exposure to the hydrogen containing air. It was confirmed that they were decayed about after 5 sec to ⅓ for the amount of transmission light and ¼ for the amount of reflection light compared with those before exposure and the amount of light was stabilized. Further, when it was returned to usual air, the amount of each light started to recover rapidly and returned to the original value usually after 20 sec of exposure to the air.

In this example, the metal oxide layer was formed by coating of the organic solvent containing tungsten oxide crystal particles and annealing, it will be apparent that the layer with crystal particles can also be formed by using any other method such as CVD, sputtering, etc. In addition, it will be apparent that similar effects can also be obtained by using metal oxide layers of molybdenum oxide crystal particles and vanadium oxide crystal particles.

While description has been made to a case of using the glass substrate for the transparent substrate in the foregoing examples regarding the hydrogen detection device, it will be apparent that substrates comprising other transparent materials such as plastics may also be used.

In the hydrogen detection devices of various shapes manufactured in the foregoing examples, while descriptions have been made to examples of using tungsten oxide, vanadium oxide and molybdenum oxide respectively, any of metal oxides selected from tungsten oxide, molybdenum oxide and vanadium oxide may be used for each of the shapes in addition to the inherent metal oxide described in each of the examples and any of catalyst film may be used so long as the material is selected from palladium and platinum.

Descriptions for the references used in the drawings of present application are as shown below.
1 light source,
2 optical fiber,
3 light detection block,
4 catalyst film,
5 gas adsorption detection film,
6 support substrate,
7 detector,
8 thin film heater,
9 heater electrode,
10 optical channel,
11 fixed end,
12 detection film,
21 reflection type light detection block,
22 light source
23 optical fiber,
24 light circulator,
25 reflection film,
26 detection gas intake port
27 detector
28 light to be detected,
29 reflection light (not exposed to detection gas),
30 reflection angle detector,
31 reflection light (exposed to detection gas),
32 detection light (not exposed to detection gas),
33 reflection light (not exposed to detection gas),
34 detection light (exposed to detection gas),
35 reflection light (exposed to detection gas
41 upper electrode for piezoelectric element
42 thin piezoelectric film,
43 lower electrode,
44 potential meter,
51 diaphragm (semiconductor substrate)
52 detection film,
53 conductive film layer,
54 capacitor film,
55 lower electrode,
56 glass substrate,
57 catalyst film and top electrode,
58 electrode pad,
59 wiring,
61 light source,
62 waveguide channel (on the introduction side),
63 detection film for temperature reference
64 gas detection film
65 waveguide channel (detection side for temperature reference),
66 waveguide channel (detection side for gas detection)
67, 68 detector,
69 semiconductor substrate,
70 thin film heater,
71 heater electrode,
72 semiconductor laser device,
73 photodiode (for temperature reference)
74 photodiode (for gas detection),
75 semiconductor laser rear face electrode,
76 high reflectance film,
80 piezoelectric material substrate,
81 detection film,
82 input side IDT electrode,
83 output side IDT electrode,
84 ground side IDT electrode,
110 glass substrate,
111 tungsten oxide film,
112 palladium pattern,
113 hydrogen detection device,
120 glass substrate,
121 palladium pattern
122 hydrogen detection device,
130 glass substrate,
131 vanadium oxide pattern,
132 platinum film,
133 hydrogen detection device,
140 glass substrate,
141 tungsten oxide film,
142 tungsten oxide pattern,
143 palladium film,
144 hydrogen detection device,
150 glass substrate,
151 tungsten oxide pattern,
152 platinum pattern,
153 hydrogen detection device,
160 glass substrate,
161 tungsten oxide layer,
162 palladium film,
163 hydrogen detection device,
170 timing generator,
171 semiconductor laser,
172 coupler,
173 input/output connector,
174A, 174B optical fiber,
175 hydrogen detection device mounted type connection connector,
176 amplifier,
177 analog/digital converter,
180A, 180B optical fiber,
181 optical lens,
182 condensing lens,
183 light detector,
190 optical fiber,
191 semiconductor laser,
192 coupler,
193 input/output connector,
194 light detector,
195 hydrogen detection device main body

1. A gas detection method comprising:
providing a detection film of a multi-layered structure comprising a first layer containing at least one layer of a first material causing volumic expansion by gas adsorption and a second layer comprising a second material with less volumic expansion by gas adsorption compared with the first material; and
measuring stress or strain caused by the stress generated in the detection film of the multi-layered structure by gas adsorption using any one of a change of light intensity, a change of reflection angle, a change of optical channel length, a change of polarization angle, a change of shape or a change of refractive index for a light incident in a direction perpendicular to a main surface of the detection film of multi-layered structure and a light transmitting through or reflected by the detection film of the multi-layered structure.

2. A gas detection method comprising:
providing a detection film of a multi-layered structure comprising a first layer containing at least one layer of a first material causing volumic expansion by gas adsorption and a second layer comprising a second material with less volumic expansion by gas adsorption compared with the first material;
allowing the detection film of multi-layered structure to include a stacked film of a cantilevered structure containing a detection film comprising WO₃ carrying or dispersing a catalyst material; and
measuring stress or strain caused by the stress generated to the detection film of multi-layered structure by gas adsorption by using any one of an optical change of light incident from a direction perpendicular to a main surface of the detection film of multi-layered structure and light transmitting through or reflected by the detection film of the multi-layered structure, or an electrical change of the piezoelectric element disposed in adjacent with the detection film of multi-layered structure.

3. A gas detection method according to claim 1, wherein the detection film of multi-layered structure is a metal oxide film of one or more of materials selected from the group consisting of WO₃, TiO₂, CuO, Cu₂O, NiO, Ni₂O₃, SiO₂, CaO, MgO, SrO, BaO, B₂O₃, BeO, Al₂O₃, MnO, MnO₂, MoO₂, Ga₂O₃, In₂O₃, Tl₂O₃, SnO₂, GeO, PbO, PtO, Co₂O₃, SrO, SeO₂, Ta₂O₅, TeO, As₂O₃, Sb₂O₃, Sb₂O₅, Bi₂O₃, Ag₂O, Au₂O₃, ZnO, VO, V₂O₃, V₂O₅, HgO, Ru₂O₃, La₂O₃, ZrO₂, CeO₂, ThO₂, Nd₂O₃, Pr₂O₃, Sm₂O₃, Ho₂O₃, Yb₂O₃, and Lu₂O₃ in which a catalyst material is carried or dispersed, or a stacked film stacked by combination of any of the metal oxide films described above, or a solid solubilized material combined with any of the metal oxide films.

4. A gas detection method according to claim 1, wherein the catalyst material carried on or dispersed in the first layer is a metal of any one of Cu, Ag, Mg, Zn, Ba, Cd, Hg, Y, La, Al, Ti, Zr, C, Si, Ge, Sn, Pb, V, Ta, Bi, Cr, Mo, W, Se, Te, Mn, Re, Fe, Co, Ni, Ru, Rh, Pd, Ir, Os, and Pt or an oxide of them, or a mixture of plurality of them.

5. A gas detection method according to claim 1, wherein the second layer is a semiconductor substrate comprising any one of Si, GaAs, and InP, or any one of SiO₂, Si₃N₄, WSi₂, WSiN, Al₂O₃, AlN, glass, sapphire, fluoro resin, polyethylene, polypropylene, acrylic resin and polyimide resin.

6. A gas detection method according to claim 1 wherein the structure of the detection film of multi-layered structure is any one of a cantilevered structure fixed at one end thereof, both end-supported structure fixed at two or more ends thereof, and circular or polygonal structure fixed at a plurality of positions thereof or along an entire periphery thereof.

7. A gas detection method according to claim 1, wherein temperature compensation is conducted by a reference device using, as the first layer, a material having the same or substantially the same heat expansion coefficient and causing less expansion due to gas adsorption, or a multi-layered film structure in which the catalyst metal carried on or dispersed in the first layer is removed to provide a structure of not causing volumic expansion caused by gas adsorption.

8. A gas detection method according to claim 1, wherein the detection performance of the detection film of multi-layered structure is stabilized by heating the detection film of multi-layered structure continuously or intermittently by a heater or irradiation of infrared rays or far infrared rays thereby keeping the detection film of multi-layered structure at a temperature from 50° C. to 300° C.

9. A gas detection method according to claim 1, comprising:
providing a detection film of a multi-layered structure comprising a first layer containing at least one layer of a first material causing volumic expansion by gas adsorption and a second layer comprising a second material with less volumic expansion by gas adsorption compared with the first material; and
electrically measuring a change of stress or strain caused by the stress generated in the detection film of multi-layered structure caused by gas adsorption by using a piezoelectric effect of a piezoelectric material stacked or bonded to the detection film of multi-layered structure, or measuring a change of stress or strains caused by the stress generated in the detection film of multi-layered structure by gas adsorption by using the change of a propagation speed of a surface acoustic wave passing through the detection film of multi-layered structure.

10. A gas detection method according to claim 1, wherein a stacked film comprising a first electrode, a piezoelectric film, and a second electrode is formed on one main surface of the detection film of multi-layered structure and the change of the stress or the strain in the detection film of multi-layered structure caused by gas adsorption is measured by using a change of voltage-current generated between the first electrode and the second electrode.

11. A gas detection method according to claim 1, wherein a stacked film comprising a first electrode, a piezoelectric film, and a second electrode is formed on one main surface of the detection film of multi-layered structure and the change of stress or the strain in the detection film of multi-layered structure caused by gas adsorption is measured by using a change of electrical capacitance generated between the first electrode and the second electrode.

12. A gas detection device comprising:
a detection film of multi-layered structure comprising a first layer containing at least one layer of a first material causing volumic expansion by gas adsorption and a second layer comprising a second material having less volumic expansion caused by gas adsorption compared with the first material;
a light source for supplying light directed to a main surface of the detection film of multi-layered structure;
a light detector for receiving light passing through or light reflected by the detection film of multi-layered structure; and
means for measuring stress or strain caused by the stress generated in the detection film of the multi-layered structure by gas adsorption using any one of a change of light intensity, a change of reflection angle, a change of optical channel length, a change of polarization angle, a change of shape or a change of refractive index for a light incident in a direction perpendicular to a main surface of the detection film of multi-layered structure and a light transmitting through or reflected by the detection film of the multi-layered structure.

13. A gas detection device according to claim 12, wherein the detection film of multi-layered structure is a WO₃ film in which a catalyst material is carried or dispersed.

14. A gas detection device according to claim 12, wherein the detection film of multi-layered structure is a metal oxide film of one or more of materials selected from the group consisting of WO₃, TiO₂, CuO, Cu₂O, NiO, Ni₂O₃, SiO₂, CaO, MgO, SrO, BaO, B₂O₃, BeO, Al₂O₃, MnO, MnO₂, MoO₂, Ga₂O₃, In₂O₃, Tl₂O₃, SnO₂, GeO, PbO, PtO, Co₂O₃, SrO, SeO₂, Ta₂O₅, TeO, As₂O₃, Sb₂O₃, Sb₂O₅, Bi₂O₃, Ag₂O, Au₂O₃, ZnO, VO, V₂O₃, V₂O₅, HgO, Ru₂O₃, La₂O₃, ZrO₂, CeO₂, ThO₂, Nd₂O₃, Pr₂O₃, Sm₂O₃, Ho₂O₃, Yb₂O₃, and Lu₂O₃ in which a catalyst material is carried or dispersed, or a stacked film stacked by combination of any of the metal oxide films described above, or a solid solubilized material combined with any of the metal oxide films.

15. A gas detection device according to claim 12, wherein the catalyst material carried on or dispersed in a first layer is a metal of any one of Cu, Ag, Mg, Zn, Ba, Cd, Hg, Y, La, Al, Ti, Zr, C, Si, Ge, Sn, Pb, V, Ta, Bi, Cr, Mo, W, Se, Te, Mn, Re, Fe, Co, Ni, Ru, Rh, Pd, Ir, Os, and Pt or an oxide of them, or a mixture of a plurality of them.

16. A gas detection device according to claim 12, wherein the second layer is a semiconductor substrate comprising any one of Si, GaAs, and InP, or any one of SiO₂, Si₃N₄, WSi₂, WSiN, A1₂O₃, AlN, glass, sapphire, fluoro resin, polyethylene, polypropylene, acrylic resin and polyimide resin.

17. A gas detection device according to claim 12, wherein an electrode is disposed in the metal oxide film by disposing an electrode to the metal oxide film constituting the first layer to prepare a resistance element and the detection film of multi-layered structure is used as a heating means, providing temperature control or stabilization of the detection performance for the detection film of multi-layered structure.

18. A gas detection device according to claim 12, wherein an input waveguide channel having a first branch and a second branch, a first output waveguide channel for receiving a light outputted from the first branch and a second output waveguide channel for receiving a light from the second branch are formed on a semiconductor substrate,
a reference element using a material having a heat expansion coefficient equal to or substantially equal to that of the first layer and with less expansion caused by gas adsorption, or a multi-layered film structure having a structure of not generating volumic expansion caused by gas adsorption by not carrying or dispersing a catalyst metal to the first layer is disposed on an optical channel connecting the first branch and the first output waveguide channel, and
a material having large expansion caused by gas adsorption or a detection film of multi-layered structure having a structure in which the volumic expansion tends to occur easily caused by gas adsorption by carrying or dispersing a catalyst metal to the first layer is disposed on an optical channel connecting the first branch and the first output waveguide channel, thereby conducting temperature compensation of the detection film of multi-layered structure with reference to the reference element.

19. A gas detection device comprising:
a first hydrogen reaction film deposited on a transparent substrate and changing optical characteristics thereof by reaction with hydrogen; and
a second hydrogen reaction film stacked on the first hydrogen reaction film and having a property of occluding and releasing hydrogen;
wherein at least one of the first and the second hydrogen reaction film is fabricated into a pattern comprising a polygonal or circular shape and a diagonal length or diameter thereof is 70 μm or less.
